(19) United States
(12) Patent Application Publication
(10) Pub. No.: US 2026/0099210 A1
(43) Pub. Date: Apr. 9, 2026

(54) MINIMALIST COMMUNICATION DEVICE

(71) Applicant: THE LIGHT PHONE INC., Brooklyn, NY (US)

(72) Inventors: Kaiwei Tang, Brooklyn, NY (US); Joseph Hollier, Brooklyn, NY (US)

(21) Appl. No.: 19/350,321

(22) Filed: Oct. 6, 2025

Related U.S. Application Data
(60) Provisional application No. 63/703,216, filed on Oct. 4, 2024.

(51) Int. Cl. G06F 3/02; G06F 3/0362; H04N 23/56; H04N 23/63; H04N 23/67

(52) U.S. Cl. CPC G06F 3/02; G06F 3/0362; H04N 23/56; H04N 23/631; H04N 23/67

(57) ABSTRACT

A mobile communication device and method of using the mobile communication device to capture a photo are provided. The mobile communication device can include a housing, a display, a camera system, a two-step shutter button, and a clickable wheel. The housing can include a front wall, a rear wall, and side walls. The display can be disposed on the front wall of the housing. The camera system can have a fixed-focal-length lens disposed in the housing. The two-step shutter button can be disposed on the housing. The two-step shutter button can be configured to focus the camera when half-pressed and capture a photo when fully pressed. The clickable wheel can be disposed on the housing and can be configured to control brightness of the display when rotated. The camera system can be configured to capture photos exclusively through actuation of the two-step shutter button.

### CROSS-REFERENCE TO RELATED APPLICATIONS

This application claims the benefit of U.S. Provisional Application No. 63/703,216, filed on Oct. 4, 2024. The entire disclosure of the above application is incorporated herein by reference.

### FIELD

The present technology relates to a mobile communication device and, more specifically, to a simplified smartphone designed to reduce digital distraction.

### INTRODUCTION

This section provides background information related to the present disclosure which is not necessarily prior art.

In recent years, smartphone usage has become ubiquitous, with the average person interacting with their device many times per day. While the smartphone offers unprecedented connectivity and access to information, the smartphone has also given rise to significant societal challenges. One of the most pressing issues associated with widespread smartphone adoption is addiction. Studies have shown that certain users spend between 5-8 hours daily on the smartphones, often compulsively checking for notifications or scrolling through social media feeds. The excessive usage can be linked to increased levels of anxiety, stress, and deteriorating mental health, particularly among younger demographics.

Attempts to address smartphone addiction have been largely ineffective thus far. Major technology companies have introduced certain digital wellbeing features that track screen time and app usage. However, these solutions often amount to little more than adding another app to an already cluttered device. Third-party applications offering timers or usage restrictions have also emerged, but the effectiveness can be limited as the applications exist within the very ecosystem the applications aim to curtail. One problem is that the smartphone manufacturer and app developer must drive engagement to make money, which can lead to a device designed with a crystal clear display, animation, and bright colors that are inherently more appealing and therefore, addictive.

One solution is to use a vintage “dumb phones” in an effort to escape the addictive nature of the smartphone. However, the simplified devices often lack modern utility features and can still include social media applications. Even flip phones from earlier iterations of mobile phone progression include a browser that allows access to the internet. Additionally, these user interfaces are colorful with animations, failing to address the root causes of digital distraction. Outdated technology and lack of ongoing support for such a device makes more outdated mobile phones an impractical long-term solution for most users.

Accordingly, there is a continuing need for a mobile communication device that offers the utility features of a modern smartphone while effectively reducing digital distractions and promoting mental well-being through a unique hardware design and operating system that discourages excessive use and minimizes addictive elements.

### SUMMARY

In concordance with the instant disclosure, a mobile communication device that offers the utility features of a modern smartphone while effectively reducing digital distractions and promoting mental well-being through a unique hardware design and operating system that discourages excessive use and minimizes addictive elements, has surprisingly been discovered.

The present technology includes articles of manufacture, systems, and processes that relate to a simplified mobile communication device for reducing digital distractions and promoting mental well-being while providing modern utility tools.

In certain embodiments, a mobile communication device can include a housing, a display, a camera system, a two-step shutter button, and a clickable wheel. The housing can include a front wall, a rear wall, and side walls. The display can be disposed on the front wall of the housing. The camera system can have a fixed-focal-length lens disposed in the housing. The two-step shutter button can be disposed on the housing. The two-step shutter button can be configured to focus the camera when half-pressed and capture a photo when fully pressed. The clickable wheel can be disposed on the housing and can be configured to control brightness of the display when rotated. The camera system can be configured to capture photos exclusively through actuation of the two-step shutter button.

In another embodiment, a method for capturing a photo using a camera system of a mobile communication device is provided. The method can include providing the mobile communication device as described herein. The method can include a step of half-pressing the two-step shutter button to focus the camera system. The method can further include a step of fully pressing the two-step shutter button to capture the photo, whereby the photo is captured.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a front bottom perspective of a mobile communication device;

FIG. 2 is a rear top perspective view of the mobile communication device;

FIG. 3 is a front elevational view of the mobile communication device;

FIG. 4 is a rear elevational view of the mobile communication device;

FIG. 5 is a right side elevational view of the mobile communication device;

FIG. 6 is a left side elevational view of the mobile communication device;

FIG. 7 is a top plan view of the mobile communication device;

FIG. 8 is a bottom plan view of the mobile communications device;

FIG. 9 is a cross sectional view of the mobile communications device taken at section line A-A of FIG. 1;

FIGS. 10A-10C are a cutaway, cross sectional view taken at cutaway B of FIG. 9 depicting a camera activation system of the mobile communication device;

FIG. 11 is a schematic depicting the mobile communication device; and

FIG. 12 is a flowchart depicting a method for capturing a photo using a camera system of the mobile communication device.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

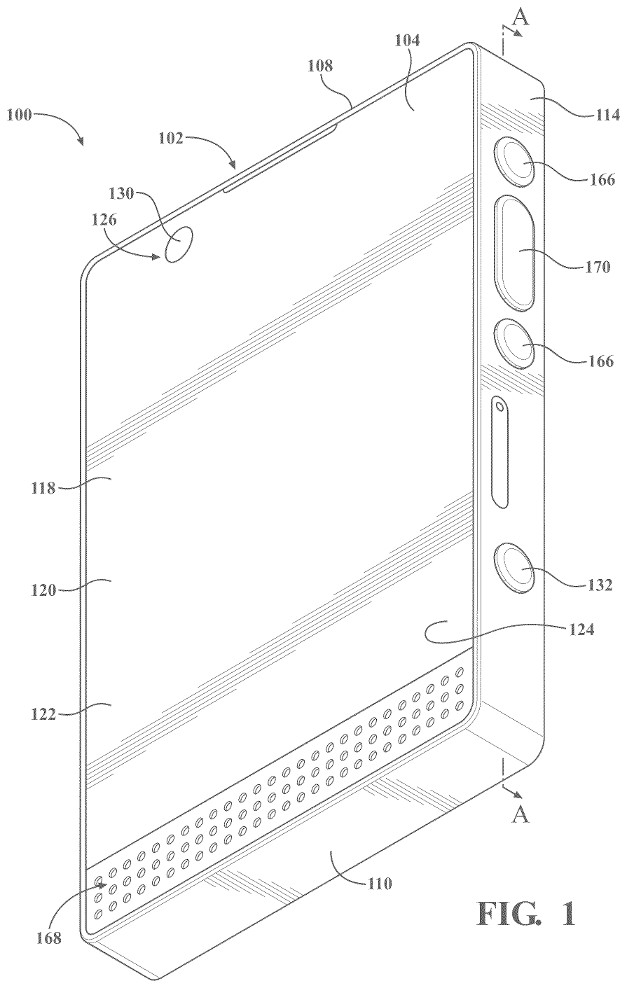

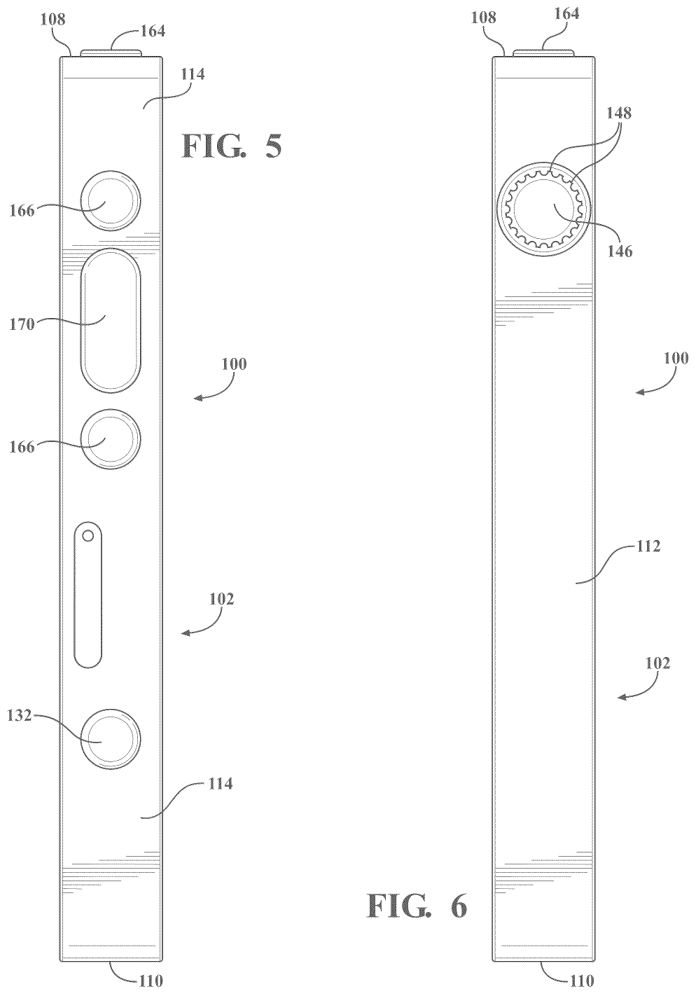

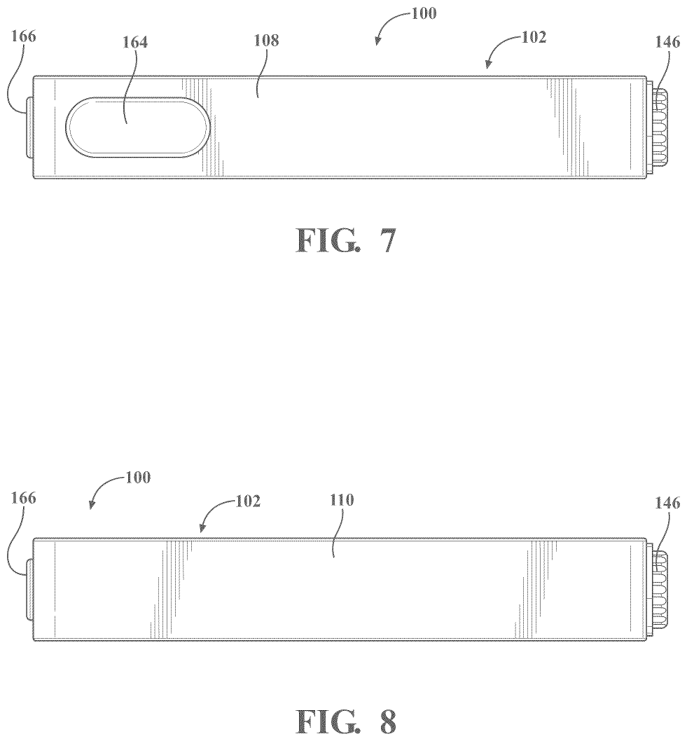

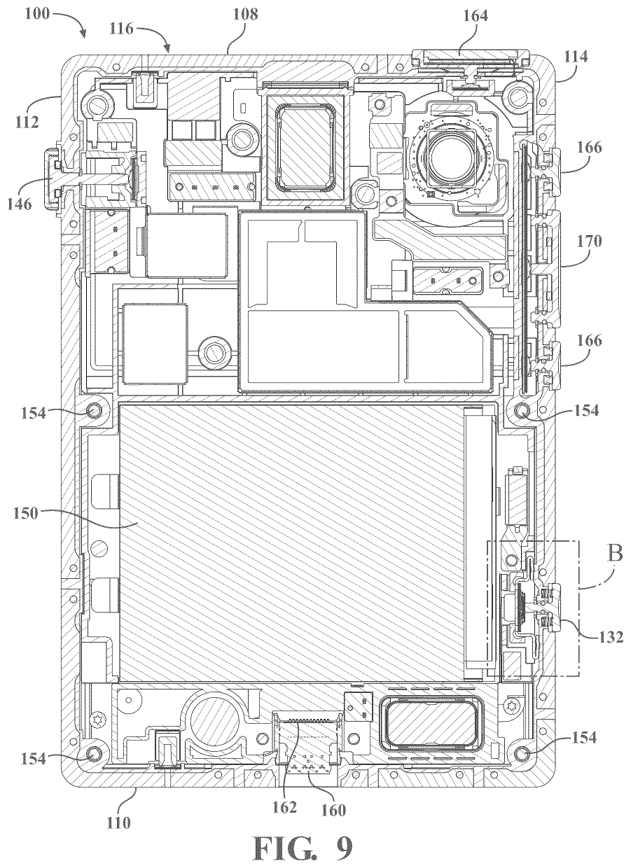

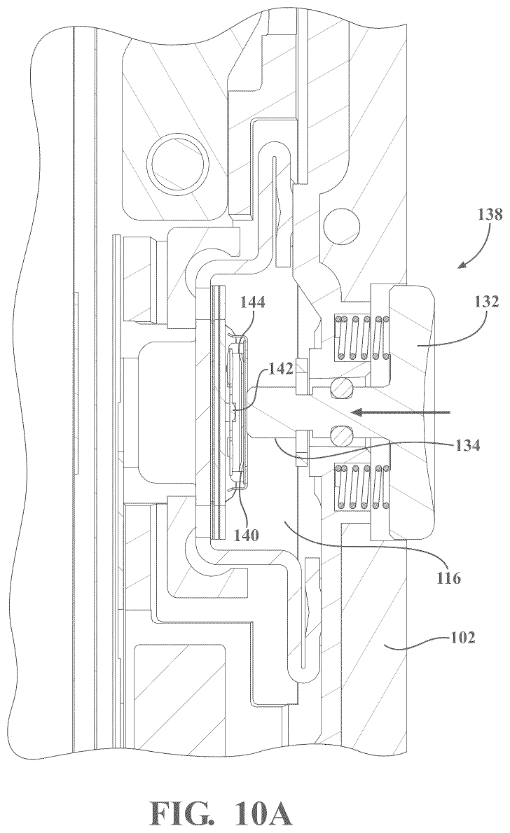

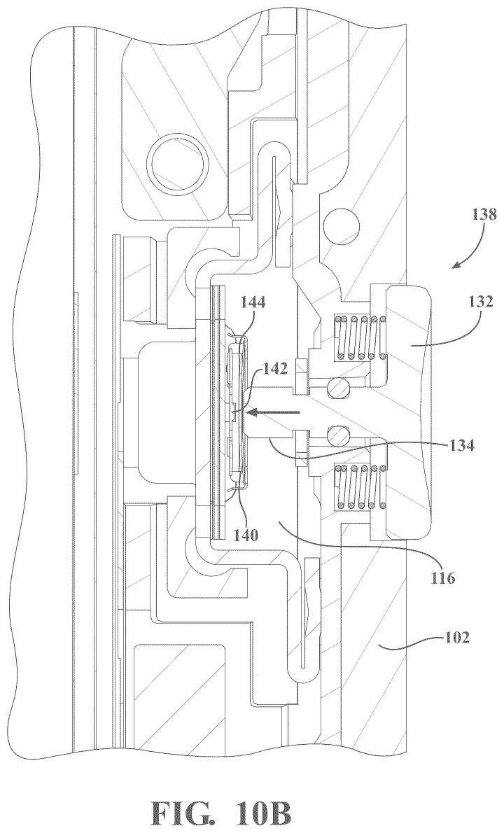

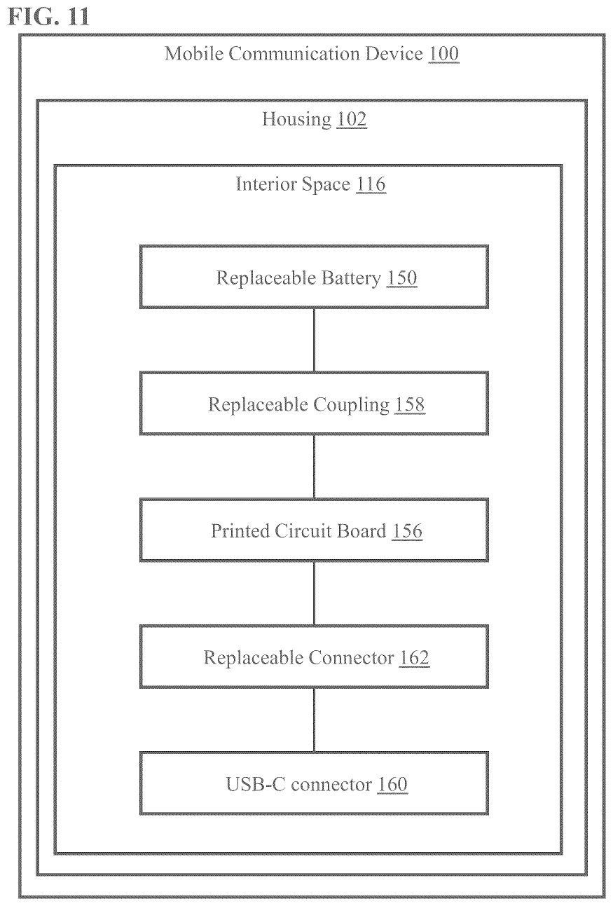

The present disclosure provides a mobile communication device 100, shown generally in FIGS. 1-11. The mobile communication device 100 can address the growing societal problem of smartphone addiction while maintaining modern functionality. The mobile communication device 100 can include a simplified mobile communication system for reducing digital distraction and promoting mental well-being by providing only fundamental technological tools without the engagement-maximizing tactics employed by other smart devices. The mobile communication device 100 can feature a unique hardware design and can be constructed from sustainable materials, along with a customized display that can create a calm appearance to discourage compulsive usage. Through a minimalist approach and intentional limitations, the mobile communication device 100 can enable a user to maintain digital connectivity while promoting a more intentional and healthy technology usage pattern.

With reference to FIGS. 1-8, the mobile communication device 100 can include a housing 102. The housing 102 can provide a compact form factor that can fit comfortably in a palm of a hand of a user, enabling convenient one-handed operation of the mobile communication device 100. To facilitate the compact nature of the mobile communication device 100, the housing 102 can have dimensions of approximately 106 mm×71.5 mm×12 mm, providing a housing 102 that can balance functionality with portability. Advantageoulsy, the compact dimensions of the housing 102 can allow the user to easily grip and manipulate the mobile communication device 100 with a single hand, facilitating natural interaction with the various controls and features disposed on the housing.

The housing 102 can be constructed from a sustainable material including aluminum, glass, and recycled plastic, for example. In certain embodiments, the housing 102 formed from aluminum can undergo a sandblasting process, resulting in a smooth surface texture that can mitigate against sharp edges despite the generally rectangular shape of the housing 102. In certain embodiments, the housing 102 can incorporate an aluminum frame combined with SORPLAS recycled plastic and matte glass components, providing both durability and environmental sustainability. Advantageously, the aluminum components can provide structural integrity while the recycled plastic elements can contribute to the environmental objectives of the mobile communication device 100.

As described herein, the housing 102 can include generally rectangular cross section. The housing 102 can include a front wall 104, a rear wall 106, a top wall 108, a bottom wall 110, a first sidewall 112, and a second sidewall 114, as shown in FIGS. 1-3. The front wall 104, the rear wall 106, the top wall 108, the bottom wall 110, the first sidewall 112, and the second sidewall 114 can generally define the rectangular configuration of the housing 102 and can likewise define an interior space 116 within the housing 102. The housing 102 can feature a smooth, refined appearance that can discourage compulsive handling while maintaining ergonomic comfort during intended use. A skilled artisan can select a suitable shake and size for the housing 102 within the scope of the present disclosure.

In certain embodiments, the housing 102 can provide water and dust resistance, offering protection against environmental elements. By militating against water and dust from entering into the housing 102, the longevity of the mobile communication device 100 can be increased. In this way, the housing can protect internal components from environmental and external damage. Water ingress into the mobile communication device 100 can cause corrosion of circuit boards, short-circuiting of electrical connections, and permanent damage to sensitive components such as processors, memory modules, and sensors, any of which can render the mobile communication device 100 inoperable. Similarly, dust infiltration can accumulate on internal components over time, potentially interfering with mechanical elements such as a button and a connector, blocking ventilation pathways that can assist with thermal management. The environmental protection of the housing 102 can complement the overall durability of the mobile communication device 100 by ensuring that the internal components remain functional throughout the intended lifespan of the mobile communication device 100.

With reference to FIG. 1, the mobile communication device 100 can include a display 118 disposed on the front wall 104 of the housing 102 to serve as a visual representation of a user interface, allowing the user to interact with and view information from the mobile communication device 100. The display 118 can be positioned to provide clear visibility and accessibility while maintaining the simplified approach of the mobile communication device 100. The display 118 can function as the primary means for the user to navigate the various tools and functions of the mobile communication device 100, presenting information in a manner that supports the minimalist nature of the mobile communication device 100.

In certain embodiments, the display 118 can include an LED screen 120, providing efficient power consumption and adequate brightness for viewing in various lighting conditions. In other embodiments, the display 118 can include an organic light-emitting diode (OLED) display 122 that can provide an optimal contrast ratio. The OLED display 122 can provide a faster response rate compared to alternative display technology, ensuring that when a user interacts with the mobile communication device 100 through texting or other functions, the response can be as fast as a smartphone display. The OLED display 122 can enable the device 100 to display color content when accessing specific tools such as the camera and album functions, while maintaining monochromatic output for all other interface elements.

The display 118 can feature a customized matte coating 124 applied over the OLED display 122 to create a visual and tactile experience for the user. In certain embodiments, the matte coating 124 can have specific technical characteristics including a haze value between about 15% and about 25% and a gloss value between about 25 to about 35, providing control over the reflective properties of the display 118. In a particular embodiment, the matte coating 124 can have a haze value of about 20% and a gloss value of about 29, providing control over the reflective properties of the display 118. In some embodiments, the special technical characteristics can be determined using methods known in the art. For example, ASTM D8082 is a laboratory testing standard for the optical clarity of nanostructured display panels. This test method evaluates the optical properties of these panels, including transmittance, haze, and specular gloss. The test involves measuring the amount of light that passes through the display 118 of the mobile communication device 100 in various directions and angles. The ASTM D8082 test procedure involves several key steps: 1. Sample preparation: A sample of the display 118 is prepared for testing. 2. Measurement of transmittance: The transmittance of the display 118 is measured using a spectrophotometer, which measures the amount of light that passes through the display 118 in various wavelengths. 3. Measurement of haze: The haze of the display 118 is measured using a haze meter, which evaluates the amount of scattered light within the display 118. Finally step 4. Measurement of specular gloss: The specular gloss of the display 118 is measured using a glossmeter, which evaluates the amount of light reflected from the surface of the display 118.

The matte coating 124 can be optimized to reduce reflection and dim the OLED display 122 output, creating a calm appearance that can discourage compulsive mobile communication device 100 usage. The customized matte coating 124 can facilitate the anti-addiction nature of the mobile communication device 100, as the customized matte coating 124 can make the mobile communication device 100 appear less visually stimulating compared to the reflective, shiny display found on a smartphone, which is particular to the smartphone to drive engagement.

As described herein, the customized matte coating 124 can be particularly useful for reducing the addictive potential of the mobile communication device 100 by significantly reducing the glossy, reflective surface that can psychologically encourage the user to interact with the mobile communication device 100. Unlike other such smartphones that can feature highly reflective displays for catching the attention of the user and promote frequent checking, the matte coating 124 can create a subdued appearance that can make the mobile communication device 100 less visually compelling when not in active use. The reduced reflection can also provide practical benefits by improving screen visibility in various lighting conditions while maintaining the calm aesthetic of the mobile communication device 100.

It should be further appreciated that the customized matte coating 124 can create a tactile experience when the user touches the display 118 surface, providing a distinctive feel that can differ significantly from a smooth glass display. The texture of the customized matte coating 124 can create a subtle drag sensation against the skin during scrolling interactions, which can naturally reduce the speed of scrolling gestures. The tactile feedback can encourage more deliberate and intentional interactions with the mobile communication device 100, supporting the overall goal of promoting mindful usage rather than rapid, compulsive scrolling behaviors common with other smartphones. The increased friction can help the user maintain better control over navigation speed, potentially reducing the tendency for endless scrolling that can contribute to addictive usage patterns.

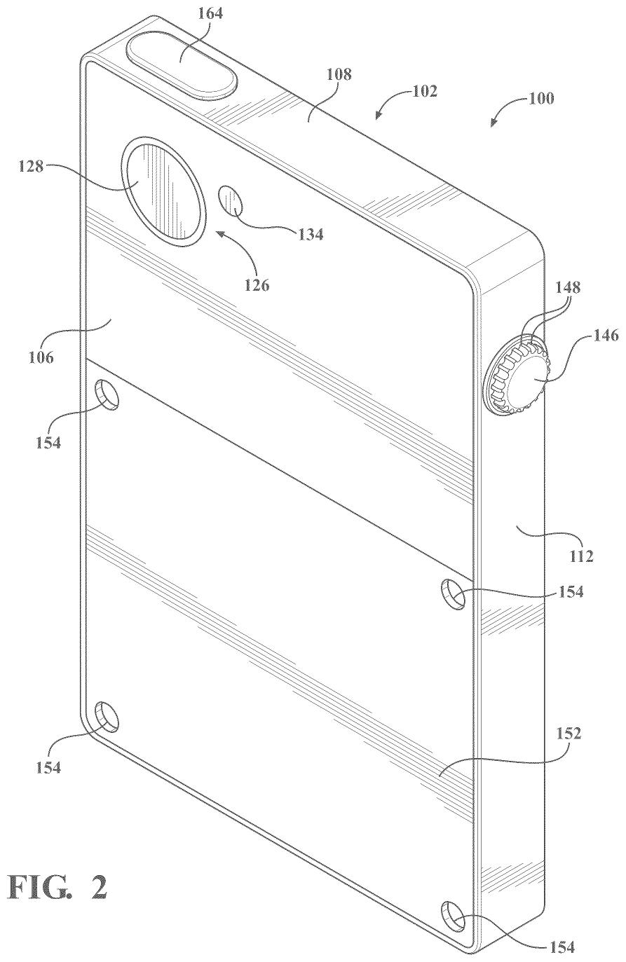

With reference to FIGS. 1-2, the mobile communication device 100 can include a camera system 126. The camera system 126 can have a fixed-focal-length lens disposed in the housing 102, providing a simplified photographic experience that reduces the complexity and potential distractions associated with variable zoom capabilities. The fixed-focal-length can facilitate consistent image quality while supporting the minimalist nature of the mobile communication device 100 by removing features that can encourage excessive photographic alteration, adjustment of camera settings, and posting capabilities to the internet or other social media platforms. The fixed-focal-length can facilitate the point-and-shoot functionality of the camera system 126, mimicking a standalone camera rather than a feature-rich camera system found in other smartphones.

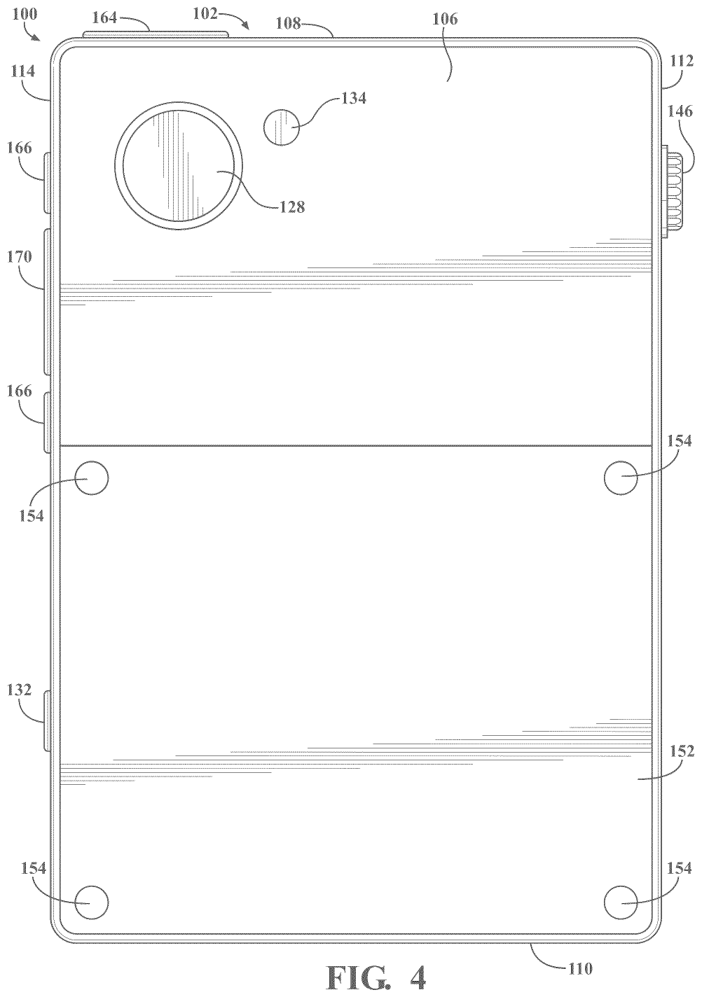

As shown in FIGS. 2 and 4, the camera system 126 can include a rear camera 128 disposed on the rear wall 106 of the housing 102, positioned to provide the photographic functionality for the mobile communication device 100. In certain embodiment, the rear camera 128 can include a 30 to 70 megapixel sensor that can be configured to output a 8 to 16 megapixel image through pixel binning In a particular embodiment, the rear camera 128 can include a 50 megapixel sensor that can be configured to output a 12 megapixel image through pixel binning, providing high-quality image capture while optimizing file size and processing efficiency. The pixel binning approach can enhance low-light performance and reduce noise while maintaining practical image file size suitable for a storage system of the mobile communication device 100 as well as the sharing capabilities of the mobile communication device 100.

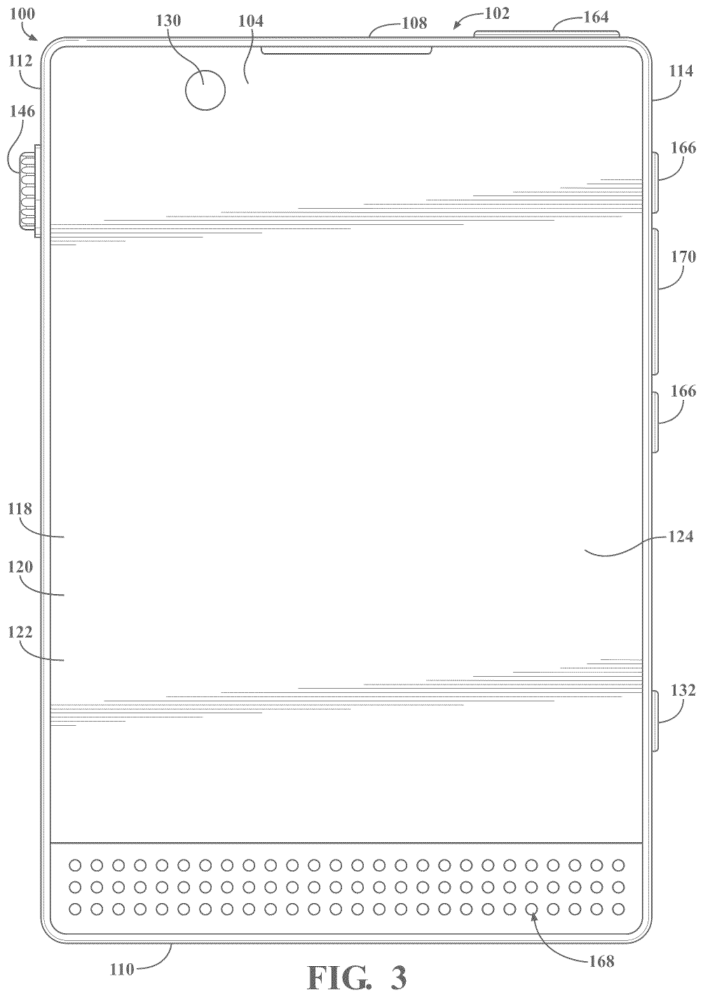

With renewed reference to FIGS. 1 and 3, the camera system 126 can also include a front camera 130 disposed on the front wall 104 of the housing 102, enabling selfie photography and video calling functionality. In certain embodiments, the front camera 130 can include an 4 to 12 megapixel sensor that can provide sufficient resolution for personal photography and video communication. In a particular embodiments, the front camera 130 can include an 8 megapixel sensor that can provide sufficient resolution for personal photography and video communication. The front camera 130 can be activated through the camera mode of the mobile communication device 100, allowing the user to switch between the rear camera 128, the front camera 130, and certain video recording functions. It should be appreciated that both of the rear camera 128 and the front camera 130 can include a fixed focal length. Alternatively, either the rear camera 128 or the front camera 130 can include a varied focal length to allow the user to zoom as desired. A skilled artisan can select a suitable camera type for the rear camera 128 and the front camera 130 within the scope of the present disclosure.

The camera system 126 can include multiple operational modes including a photo mode, a video mode, and a selfie mode, for example, that can be selectable through use of a two-step shutter button 132. The photo mode, the video mode, and the selfie mode can provide the user with the variable photographic functions needed for documenting experiences while maintaining the simplified operational approach that characterizes the mobile communication device 100. The camera system 126 can be configured to capture a photo exclusively through actuation of the two-step shutter button 132. It should be appreciated that the exclusivity of capturing the photo through use of the two-step shutter button 132 negates the ability of the user from taking photos through the display 118 interface and thereby maintains the point-and-shoot camera experience.

In certain embodiments, the camera system 126 can include a flashlight 134 disposed adjacent to the rear camera 128, which can be controllable through certain features of the housing. The flashlight 134 can provide illumination for photography in low-light conditions, and the user can adjust the camera flash setting by actuating a button or protrusion on the housing 102 to control the light level of the flashlight 134. The integration of the flashlight 134 control with the physical button can support the emphasis on tactile, non-screen-based controls for camera operations. A skilled artisan can select a suitable mechanism for adjusting the brightness of the flashlight 134 within the scope of the present disclosure.

It should be appreciated that the mobile communication device 100 and the camera system 126 can allow for the photo captured to be displayed in color only when viewed through an album tool, while all other interface elements of the mobile communication device 100 remain monochromatic. The selective color display can maintain the minimalist visual nature of the interface of the mobile communication device 100 while ensuring that photographic content retains the natural color representation when specifically accessed for viewing. Additionally, when a photo is received through a text message, the photo can be automatically converted to a monochromatic icon for display in the message thread interface, with the transition from the monochromatic icon to the full color image occurring through a single user interaction.

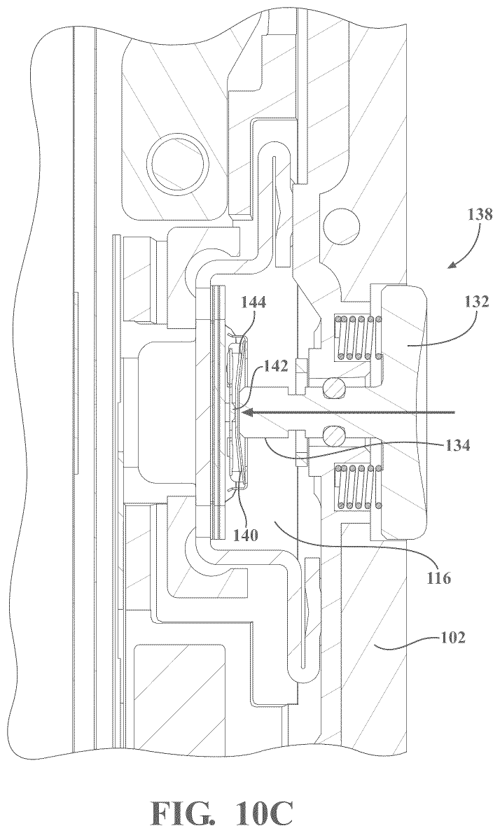

As shown in FIGS. 1 and 10A-10C, the camera system 126 can be operated exclusively through the two-step shutter button 132 disposed on the housing 102, which can be configured to focus either the rear camera 128 or the front camera 130 when half-pressed, as shown in FIG. 10B, and capture a photo using either of the rear camera 128 or the front camera 130 when fully pressed, as shown in FIG. 10C. The two-step shutter button 132 can be positioned on either of the first sidewall 112 and the second sidewall 114 of the housing 102, allowing for comfortable single-handed operation while maintaining the ergonomic nature of the mobile communication device 100. A skilled artisan can select a suitable position for the two-step shutter button 132 within the scope of the present disclosure.

With reference to FIGS. 10A-10C, a portion 136 of the two-step shutter button 132 can extend into the interior space 116 of the housing 102. The interior space 116 of the housing 102 can contain a camera activation system 138. The camera activation system 138 can have a pad 140 and an actuation button 142 disposed within the housing 102 adjacent the portion 136 of the two-step shutter button 132 that extends within the housing 102. The pad 140 can be configured to signal to the camera system to focus when the two-step shutter button 132 is half-pressed, while the actuation button 142 can be configured to signal to the camera system 126 to capture the photo when the two-step shutter button 132 is fully pressed. The internal mechanism can ensure reliable and precise control over the focusing and capture functions of the camera system 126, providing the user with the tactile feedback necessary for confident operation.

As shown in FIG. 10A, the pad 140 can be disposed closer to the two-step shutter button 132 than the actuation button 142, creating a sequential activation system that corresponds to the two-step operation. The pad 140 can include a concave surface 144 opposite the actuation button 142, and the two-step shutter button 132 can be configured to deflect the concave surface 144 of the pad 140 when half-pressed, whereby the pad 140 signals to focus the camera system 126. The mechanical configuration can provide clear tactile distinction between the focusing step and the capture step, allowing the user to feel when optimal focus has been achieved before proceeding to capture the photo.

As shown in FIGS. 2-4, the mobile communication device 100 can include a clickable wheel 146 disposed on the housing 102, which can be configured to control brightness of the display 118. In certain embodiments, the clickable wheel 146 can be disposed on either of the first sidewall 112 or the second sidewall 114, opposite the two-step shutter button 132. Advantageously, this can create a balanced control layout that facilitates comfortable one-handed operation. The clickable wheel 146 can include a plurality of bumpers 148 disposed about the circumference of the clickable wheel 146 to provide a tactile surface for gripping with a finger and to help protect against accidental damage from falls. Desirably, the clickable wheel 146 can provide the user with a tactile, physical control mechanism that supports the emphasis on non-screen-based interactions.

The clickable wheel 146 can be customized to control various functions including brightness of the display 118 and/or the flashlight 134, volume, zoom functionality, scrolling functionality, and font size of the display 118, providing versatile functionality through the user interface. When rotated, the clickable wheel 146 can allow the user to quickly adjust the display 118 brightness without requiring navigation through an on-screen menu via the user interface, supporting the goal of minimizing screen-based interaction. The clickable wheel 146 can also be configured to control volume, providing an alternative method for audio level adjustment that complements the volume button disposed on the housing 102. It should be appreciated that the user can select certain settings for the clickable wheel 146 to control.

In addition to rotational controls, the clickable wheel 146 can be configured with a clicking function that can be activated by pressing the clickable wheel 146 against the housing 102. When clicked, the clickable wheel 146 can activate the flashlight 134 on the mobile communication device 100, providing the user with immediate access to illumination functionality. A skilled artisan can select suitable controls for the clickable wheel 146 within the scope of the present disclosure.

The clickable wheel 146 can also be integrated with the camera system 126 functionality, allowing the user to control camera flash settings by rotating the wheel to adjust the light level of the flashlight 134 when using either the rear camera 128 or the front camera 130. The integration can provide the user with precise control over illumination while maintaining an emphasis on physical control rather than screen-based adjustment. The clickable wheel 146 can be constructed from custom metal materials as selected by a skilled artisan.

With reference to FIG. 2, the positioning of the clickable wheel 146 can be strategically located to provide ergonomic access while militating against accidental activation during normal handling of the mobile communication device 100. The clickable wheel 146 can be disposed on the housing 102 in a location that allows natural thumb or finger access when the mobile communication device 100 is held in a standard grip position, supporting one-handed operation while maintaining the simplified control nature that characterizes the overall user experience.

In certain embodiments, the mobile communication device 100 can include a battery 150 that can enable operation of the mobile communication device 100, providing the user with the ability to maintain the mobile communication device 100 for an extended period. In some embodiments, the battery 150 can be a rechargeable battery that may be periodically charged with an electrical source conveniently connected to a cable, for example, a USB-C connector 160 operatively connected with the communication device 100.

In some embodiments, the mobile communication device 100 can include a replaceable battery 150 that can enable operation of the mobile communication device 100, providing the user with the ability to maintain the mobile communication device 100 for an extended period. It should be appreciated that the monochromatic user interface and OLED display 122 can aid in reducing the expenditure of the replaceable battery 150 and extending the performance of the replaceable battery 150. For example, the replaceable battery 150 can allow the mobile communication device 100 to operate for a period of about 2 to 3 days, depending on usage and user preferences such as display 118 brightness and flashlight 134 use. The replaceable battery 150 can have a capacity of 1800 mAh, offering power storage for the mobile communication device 100 while supporting longer usage periods between charges.

The replaceable battery 150 can significantly extend the operational lifespan of the mobile communication device 100 by allowing the user to replace the battery 150 when the battery 150 begins to degrade over time. It should be appreciated that the battery 150 can present as one of the first components to fail in a phone, and the replaceable nature of the replaceable battery 150 can enable the device to last substantially longer rather than requiring complete replacement when battery 150 performance diminishes. For this purpose and as shown in FIG. 4, the rear wall 106 of the housing 102 can include a battery door 152 coupled to the housing 102 with a fastener 154 allowing the replaceable battery 150 to be removable without requiring a specialized tool or professional service. In certain embodiments, the fastener 154 can include at least four fasteners, with each fastener positioned approximately 3.8 mm from an edge of the battery door 152, providing secure attachment while maintaining accessibility for user replacement. In certain embodiments, the replaceable battery 150 can be coupled to a printed circuit board 156 via a replaceable coupling 158, reducing the need for a soldered connection between the replaceable battery 150 and the printed circuit board 156. The replaceable coupling 158 can allow for easy battery 150 replacement while reducing the risk of damage to the printed circuit board 156 or other internal components.

In certain embodiments, the mobile communication device 100 can include a USB-C connector 160 that can be connected to a printed circuit board 156 via a replaceable connector 162, providing serviceability of the mobile communication device 100. The replaceable connector 162 configuration can enable the user to replace the USB-C connector 160 independently without requiring replacement of the entire printed circuit board 156 or the mobile communication device 100. The USB-C connector 160 can provide charging and data transfer capabilities for mobile communication device 100 in operation.

The mobile communication device 100 can include a power button 164 disposed on the housing 102 that can function as both a power control and fingerprint sensor to allow for access to the mobile communication device 100. The dual functionality can provide the user with convenient device security while maintaining the simplified control. The power button 164 can be positioned on the top wall 108 of the housing 102, allowing for easy access during normal device handling, as shown in FIG. 2.

The power button 164 can be configured to activate or deactivate the mobile communication device 100 when held for a set interval of time, providing power control functionality. Additionally, the fingerprint sensor capability can enable the user to unlock the mobile communication device 100 by pressing the power button during the power-on sequence, reducing the need for a separate unlocking procedure or additional hardware components. The integration can support user security while maintaining the minimalist hardware approach of the mobile communication device 100 and can provide seamless access to the functions of the mobile communication device 100 without requiring complex authentication procedures that might discourage regular use of security features.

With renewed reference to FIG. 1, the mobile communication device 100 can include at least one volume control button 166 disposed on either the first sidewall 112 or the second sidewall 114 opposite the clickable wheel 146, providing balanced control placement that supports comfortable one-handed operation. The positioning of the at least one volume control button 166 can create an ergonomic control layout where users can access volume adjustment on one side of the device while having brightness and other wheel-controlled functions available on the opposite side. The volume control button 166 can be positioned to complement the overall button arrangement on the housing 102, which can include a volume up button and a volume down button that can have a specific size, shape, and curvature to improve ergonomics and ease of use as selected by a skilled artisan.

The strategic placement of the volume control button 166 opposite the clickable wheel 146 can militate against accidental activation of multiple controls simultaneously and can provide the user with intuitive control access regardless of how the mobile communication device 100 is held. The arrangement of buttons can support the emphasis on physical, tactile controls rather than screen-based volume adjustments, maintaining the simplified interaction philosophy that characterizes the overall user experience of the mobile communication device 100.

The mobile communication device 100 can operate with a monochromatic user interface except when displaying the photo capture by the camera system 126, creating a distinctive visual experience that supports the anti-addiction nature of the mobile communication device 100. The monochromatic approach can reduce the colorful, attention-grabbing interface elements that are commonly used to drive user engagement. In operation, when a photo is received or sent through a text message, the photo can be automatically converted to a monochromatic icon for display in a message thread interface, maintaining the consistent black and white visual scheme throughout the messaging experience. The monochromatic icon can provide the user with a visual indication that the photo has been received while preserving the simplified interface. The transition from the monochromatic icon to a color image can occur through a single user interaction, such as tapping the monochromatic icon on the display 118 allowing the user to view the full-color content when desired.

The photo captured by the camera system 126 can be displayed in color only when viewed through an album tool, while all other interface elements remain monochromatic. The selective color display can ensure that photographic content retains the natural color representation when specifically accessed for viewing, while maintaining the minimalist visual representation throughout all other functions.

In certain embodiments, the mobile communication device 100 can include a speaker grill 168 disposed on the front wall 104 of the housing 102, positioned on the lower front portion of the housing 102 below the display 118, for example and as shown in FIG. 1. The speaker grill 168 can enhance airflow from the interior space 116 of the housing 102, which can result in improved sound and audio quality. The speaker grill 168 can provide the necessary depth for optimal acoustics, enabling the mobile communication device 100 to project sound effectively for voice calls and audio playback.

In another embodiment, the mobile communication device 100 can include a home button 170 disposed on the housing 102 and can be configured to be actuated when pressed at top and bottom edges of the home button 170. The home button 170 can be the largest and longest button on the mobile communication device 100, allowing for activation even when pressed at the very edges of the home button 170. The home button 170 can be disposed on either of the OLED display 122 or the second sidewall 114 of the housing, and in certain embodiments, the home button can be disposed between the volume buttons 166. The home button 170 can serve as a navigation element that can allow the user to return to the main interface or home screen of the mobile communication device 100, providing tactile feedback and reliable operation even when activated at multiple contact points along the length.

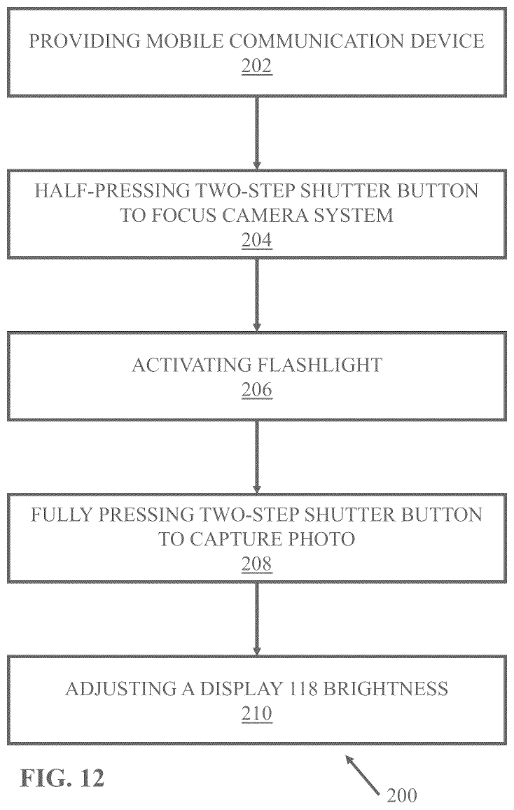

The present disclosure further provides a method 200 for capturing a photo using a camera system of a mobile communication device, shown generally in FIG. 12. The method 200 can include a step 202 of providing the mobile communication device as described herein. A user can half-press the two-step shutter button 132 to focus the camera system 126 in a step 204.

In a step 206, the method 200 can include including activating the flashlight 134 by clicking the clickable wheel 146 disposed on the housing 102 to provide illumination for the photo. The method 200 can further include a step 208 of fully pressing the two-step shutter button 132 to capture the photo, whereby the photo is captured. The method 200 can include a step 210 of adjusting a display 118 brightness by rotating the clickable wheel 146.

The mobile communication device 100 incorporates several features that contribute to the minimalist philosophy and reduced digital distraction approach. The camera system 126 operates exclusively through the dedicated two-step shutter button 132, reducing the need for touchscreen interaction to operate the camera system 126 and utilizing a point-and-shoot camera functionality where half-pressing focuses the lens and full depression captures the photo. Further the camera system 126 and the two-step shutter button 132 removes the smartphone camera interface, which can include editing tools, filters, sharing capabilities, and social media integration, instead providing only the documenting function without any engagement-maximizing features.

The clickable wheel 146 allows the user to quickly adjust display 118 brightness through rotation and activate the flashlight 134 through a straight-forward click action. The physical control mechanism reduces the need to navigate through digital menus and settings screens, providing immediate tactile feedback and reducing the time spent interacting with the interface. Additionally, the display 118 reinforces the minimalist approach through the matte coating 124 of the OLED display 122 that reduces reflection and dims the display 118 output, creating a calm visual experience that contrasts sharply with the glossy, attention-grabbing screens of other devices. The mobile communication device 100 operates with a monochromatic user interface except when displaying captured photographs, further reducing visual stimulation and reducing colorful animation and graphics designed to maximize user engagement. Together, the features create a cohesive mobile communication device 100 that provides modern utility while actively discouraging excessive use and digital distraction.

### EXAMPLES

Example embodiments of the present technology are provided with reference to the figures enclosed herewith.

A user steps out of an apartment on a Saturday morning, the mobile communication device 100 tucked away in a jacket pocket. The user heads to the local farmers market to enjoy a morning walk, with the mobile communication device 100 remaining an unobtrusive companion, free from constant notifications or the compulsive urge to document every moment for online validation.

At the market, the user discovers a vendor selling heirloom tomatoes arranged in wooden crates and decides to capture the scene to share with a friend. Without navigating through camera apps or touchscreen interfaces, the user retrieves the mobile communication device 100 and positions the mobile communication device 100 toward the display. The morning light proves too bright for the display 118, so the user rotates the clickable wheel 146 to adjust the display 118 brightness and reduce glare.

With the scene framed, the user engages the two-step shutter button 132 with deliberate motion. The half-press allows the fixed-focal-length lens to focus on the tomatoes, providing tactile feedback that confirms the rear camera 128 has locked onto the subject. A full press of the two-step shutter button 132 captures the photo in a single moment—no burst modes, no automatic uploads, no pressure to add filters or captions. The photo exists as a preserved moment, ready to be shared through a text message without engagement-driven features that turn photos into content creation.

As the user continues the market visit, the realization occurs that the mobile communication device 100 has remained what was intended, a tool that enhanced the experience rather than dominating it. The photo represents a genuine moment of connection captured through a natural process. Unlike previous smartphone habits where taking photos meant missing the actual experience while managing complex camera interfaces and immediately sharing to social platforms, the simplified approach of the mobile communication device 100 allowed the user to remain present while preserving the moment. The minimalist nature transforms photography from an addictive behavior back into a way to document and share meaningful moments.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A mobile communication device comprising:
a housing having a front wall, a rear wall, and side walls;
a display disposed on the front wall of the housing;
a camera system having a fixed-focal-length lens disposed in the housing;
a two-step shutter button disposed on the housing, the two-step shutter button configured to focus the camera when half-pressed and capture a photo when fully pressed;
a clickable wheel disposed on the housing, the clickable wheel configured to control brightness of the display when rotated; and
wherein the camera system is configured to capture photos exclusively through actuation of the two-step shutter button.

2. The mobile communication device of claim 1, wherein the housing includes a camera activation system having a pad and an actuation button and disposed inside the housing adjacent the two-step shutter button, the pad configured to signal to the camera system to focus when the two-step shutter button is half-pressed and the actuation button configured to signal to the camera system to capture the photo when the two-step shutter button is fully pressed.

3. The mobile communication device of claim 2, wherein the pad is disposed closer to the two-step shutter button than the actuation button.

4. The mobile communication device of claim 2, wherein the pad includes a concave surface opposite the actuation button.

5. The mobile communication device of claim 4, wherein the two-step shutter button is configured to deflect the concave surface of the pad when half-pressed, whereby the pad signals to focus the camera system.

6. The mobile communication device of claim 1, further including a flashlight disposed adjacent to the camera, wherein the flashlight is controllable through the clickable wheel.

7. The mobile communication device of claim 1, where the camera system includes a 30 to 70 megapixel sensor configured to output 8 to 16 megapixel images through pixel binning.

8. The mobile communication device of claim 1, wherein the two-step shutter button is positioned on a side wall of the housing.

9. The mobile communication device of claim 1, wherein a captured by the camera system is displayed in color only when viewed through a dedicated album tool, while all other interface elements remain monochromatic.

10. The mobile communication device of claim 1, wherein the mobile communication device operates with a monochromatic user interface except when displaying captured photographs.

11. The mobile communication device of claim 1, wherein an image received through a text message is automatically converted to a monochromatic icon for display in a message thread interface.

12. The mobile communication device of claim 11, wherein a transition from the monochromatic icon to a color image occurs through a single user interaction.

13. The mobile communication device of claim 1, wherein the housing includes a rear wall having a battery door coupled to the housing with a fastener, a replaceable battery being removable.

14. The mobile communication device of claim 1, wherein the display includes an organic light-emitting diode (OLED) display having a matte coating configured to reduce reflection and dim a display output.

15. The mobile communication device of claim 14, wherein the matte coating has a haze value of 15% to 25% and a gloss value of 25 to 35.

16. The mobile communication device of claim 1, further including a USB-C connector connected to a printed circuit board via a connector.

17. The mobile communication device of claim 1, comprising a replaceable battery, wherein the replaceable battery is coupled to a printed circuit board via a replaceable coupling.

18. A method for capturing a photo using a camera system of a mobile communication device, comprising:
providing the mobile communication device including
a housing having a front wall, a rear wall, and side walls,
a display disposed on the front wall of the housing,
a camera system having a fixed-focal-length lens disposed in the housing,
a two-step shutter button disposed on the housing, the two-step shutter button configured to focus the camera when half-pressed and capture a photo when fully pressed,
a clickable wheel disposed on the housing, the clickable wheel configured to control brightness of the display when rotated, and
wherein the camera system is configured to capture photos exclusively through actuation of the two-step shutter button;
half-pressing the two-step shutter button to focus the camera system; and

19. The method of claim 18, further including adjusting a display brightness by rotating the clickable wheel.

20. The method of claim 18, further including activating a flashlight by clicking the clickable wheel disposed on the housing to provide illumination for the photo.
